(19) United States
(12) Patent Application Publication
(10) Pub. No.: US 2023/0236280 A1
(43) Pub. Date: Jul. 27, 2023

(54) METHOD AND SYSTEM FOR POSITIONING INDOOR AUTONOMOUS MOBILE ROBOT

(71) Applicant: TAIZHOU UNIVERSITY, Taizhou City (CN)

(72) Inventors: Pengzhan CHEN, Taizhou City (CN); Yuanming LI, Taizhou City (CN); Lixian WANG, Taizhou City (CN)

(73) Assignee: TAIZHOU UNIVERSITY, Taizhou City (CN)

(21) Appl. No.: 17/820,923

(22) Filed: Aug. 19, 2022

(30) Foreign Application Priority Data
Jan. 25, 2022 (CN) 202210085378.0

(51) Int. Cl. G01S 5/02; G06T 7/73; G06T 7/50

(52) U.S. Cl. CPC G01S 5/0264; G01S 5/0294; G06T 7/73; G06T 7/50; G01S 2205/02; A01K 1/01

(57) ABSTRACT

A method and system for positioning an indoor autonomous mobile robot is disclosed in this application, which includes: indoor layout of moving paths and indoor relative position information of the moving path are obtained by a vision sensor; visual positioning is performed by a visual locator on indoor image data collected by the visual sensor to obtain the first position information; and second position information of a UWB location tag is obtained and solved by an UWB locator; the first position information and the second position information are fused by an adaptive Kalman filter, to obtain final positioning information of the autonomous mobile robot. After fusion, the UWB locator can correct the accumulated error caused by visual positioning, and at the same time, visual positioning can smooth measured data of the UWB locator to make up for deficiencies.

### CROSS REFERENCE TO RELATED APPLICATION

This Non-provisional application claims priority under 35 U.S.C. § 119(a) to Chinese Patent Application No. CN202210085378.0, filed on 25 Jan. 2022, the entire contents of which is hereby incorporated by reference in its entirety.

### TECHNICAL FIELD

The disclosure belongs to a technical field of indoor autonomous mobile robot positioning, and particularly relates to a method for positioning an indoor autonomous mobile robot.

### BACKGROUND ART

Building breeding is an emerging breeding mode, which has advantages of saving land, being environmentally friendly, ease of management, good ventilation and lighting, high degree of mechanization, high efficiency and low cost. Therefore, the building breeding has gradually become a development trend of the future breeding industry and even the whole animal husbandry. In order to improve efficiency of scale breeding, mechanized manure cleaning is generally adopted. Therefore, many manure cleaning robots were born in the market. Positioning is one of its main problems in autonomous operations of a manure cleaning robot.

Currently, positioning methods commonly used in the field of autonomous mobile robots are as follows:

(1) Positioning method based on beacon. The autonomous mobile robot recognizes pre-arranged beacons during moving and calculates to obtain pose information by triangulation and other methods. This method is easy to be implemented and has high accuracy, but it needs reasonable layout of beacons, and installation and maintenance costs are high.

(2) Positioning method based on laser. Real-time information of the robot relative to the environment is collected by a lidar, and an acquired point cloud set is processed, so as to obtain the pose information of the robot. Laser positioning technologies are with high precision, which can be used not only for robot positioning, but also for obstacle avoidance and navigation. However, most of laser sensors are expensive and prone to distortion.

(3) Positioning method based on sound. For this technology, a sound-emitting object is identified through its timbre, and then tasks such as positioning and tracking can be performed. Positioning technologies based on the sound is low in cost, but it is greatly influenced by noise and has a large amount of computing.

(4) Vision-based positioning method. In visual positioning, acquisition of a camera and other sensor data are deeply integrated, and more six-degree-of-freedom pose information (including orientation information and three-dimensional position information) are returned regarding information dimensions, which covers accurate positioning of parts of indoor or outdoor scenes and supports accurate superimposition display of virtual contents, and has functions of accurate spatial positioning, high-precision three-dimensional map reconstruction and virtual-actual fusion and superposition. However, cumulative errors can be produced in long-term operations.

A floor breeding shed is complex and huge in structure with dozens of manure paths on each floor, respective ones of which are roughly but not completely the same. Environment in the manure path is poor and the manure cleaning robot may be affected by light, noise, uncertain environment and other conditions in positioning. A manure cleaning robot can automatically locate and navigate to a plurality of manure paths for operation. In this huge and complex operation environment, the current positioning methods can't meet positioning requirements of the manure cleaning robot.

### SUMMARY

The present disclosure aims at solving one of technical problems in related art at least to a certain extent, in which a method for positioning an indoor autonomous mobile robot is provided, which includes following content.

Indoor layout of moving paths and indoor relative position information of the moving path are obtained by a vision sensor on the autonomous mobile robot.

The autonomous mobile robot is provided with a visual locator, and visual positioning is performed by the visual locator on indoor image data collected by the visual sensor to obtain the first position information.

The autonomous mobile robot is provided with an ultra-wide band (UWB) location tag, and second position information of the UWB location tag is obtained and solved by an UWB locator.

The first position information and the second position information are fused by an adaptive Kalman filter, to obtain final positioning information of the autonomous mobile robot.

The vision sensor is an instrument that acquires image information about the external environment using optical elements and an imaging device, and its main function is to acquire the most original image. The visual locator analyzes the image information acquired by the vision sensor and converts it into position information.

The UWB location tag can transmit ultra-wideband positioning signals to determine the location. The UWB locator can integrate all ultra-wideband positioning signals, acquire, analyze and transmit information to users and other related information systems.

Optionally, the indoor layout of the moving paths and the indoor relative position information of the moving path are obtained by the vision sensor on the autonomous mobile robot, which specifically includes following content. The indoor moving paths are numbered, and the layout and the relative position information of the moving paths are integrated, and then the moving paths are characterized by using two-dimensional codes respectively. The autonomous mobile robot identifies the two-dimensional codes to obtain respective layout and relative position information of the moving paths.

Optionally, the visual positioning is performed by the visual locator on the indoor image data collected by the visual sensor to obtain the first position information, which specifically includes following content.

The indoor image data is collected by the vision sensor in real time at a preset frame rate, and images of two consecutive frames are taken.

Common key points from the images of two consecutive frames are extracted by the visual locator, so as to obtain depth coordinates of the key points.

Mismatched points are removed in a matching pair to improve accuracy of visual positioning.

A trajectory of the autonomous mobile robot moving in indoor is obtained according to continuous iteration for the depth coordinates.

The preset frame rate is 10 to 30 frames per second. A step in which the mismatched points are removed in the matching pair specifically is to match the common key points in the two frames of images, with matched points being reserved and mismatched points being removed.

Specifically, the vision sensor continuously obtains images at a certain frame rate. First, we take two consecutive images for location calculation, and then continue to iterating. Because the autonomous mobile robot is moving, a position of the robot is different at these two moments.

Optionally, the autonomous mobile robot is provided with an ultra-wide band (UWB) location tag, and second position information of the UWB location tag is obtained and solved by an UWB locator, which specifically includes following content.

The autonomous mobile robot is provided with the UWB location tag and a plurality of UWB anchors are provided around the moving paths.

The UWB anchor can receive and estimate the signals sent from the UWB location tag. By measuring signal time from the UWB location tag to the UWB anchor, a distance from the UWB location tag to the UWB anchor is obtained, and the second position information of the UWB location tag is calculated and obtained by the UWB locator.

Optionally, after the first position information and the second position information are time synchronized, the first position information and the second position information are fused by the adaptive Kalman filter to obtain the final positioning information.

Optionally, the first position information and the second position information are fused by the adaptive Kalman filter to obtain the final positioning information, which specifically includes following content. The first position information is converted into a measured distance value; that is, after measured distance values of the UWB locator and the visual locator are obtained respectively, difference between the measured distance values of the UWB locator and the visual locator is configured as a measurement input of the adaptive Kalman filter, and the final positioning information is obtained after filtering by the adaptive Kalman filter.

The measured distance value refers to a numerical value of the distance. A distance between the UWB location tag and the UWB anchor is the measured distance value of the UWB locator. The first position information is converted into a measured distance value which is a measured distance value of the visual locator.

The present disclosure aims at solving one of technical problems in related art at least to a certain extent, in which a system for positioning an indoor autonomous mobile robot is provided, which includes a recognizer, a visual locator, a UWB locator and an adaptive Kalman filter.

The recognizer is configured for obtaining preset layout of moving paths and relative position information of the moving paths.

The visual locator is configured for collecting indoor image data for visual positioning to obtain first position information.

The UWB locator is configured for obtaining signal time and distances from the UWB location tag to a plurality of UWB anchors provided on the moving path, and solving the second position information of the UWB location tag;

The adaptive Kalman filter is configured for fusing the first position information and the second position information to obtain final positioning information.

Specifically, the recognizer can be a vision sensor.

Optionally, the system for positioning the indoor autonomous mobile robot further includes a memory device configured to number the indoor moving paths and integrate the layout and relative position information of the moving paths so as to be stored in the memory device. Then, the moving paths are characterized by using two-dimensional codes, and the recognizer can identify the two-dimensional codes to obtain respective layout and relative position information of the moving paths.

The memory device is an industrial control computer installed on the autonomous mobile robot, and all information is stored in a computer system of the industrial control computer. The industrial control computer can be an NVIDIA Jetson AGX Xavier microcomputer.

Optionally, collecting the indoor image data for visual positioning to obtain the first position information specifically includes:

collecting the indoor image data by the vision sensor in real time at a preset frame rate of 10-30 frames/second, and taking images of two consecutive frames;

extracting common key points from the images of two consecutive frames so as to obtain depth coordinates of the key points; and

obtaining a trajectory of the autonomous mobile robot moving in space according to continuous iteration for the depth coordinates.

Optionally, obtaining and solving the second position information of the UWB location tag by the UWB locator specifically includes:

obtaining a distance from the UWB location tag to the UWB anchor by measuring signal time from the UWB location tag to the UWB anchor, and calculating and obtaining the second position information of the UWB location tag.

Optionally, after the first position information and the second position information are time synchronized, the first position information is converted into a measured distance value; that is, after measured distance values of the UWB locator and the visual locator are obtained respectively, difference between the measured distance values of the UWB locator and the visual locator is configured as a measurement input of the adaptive Kalman filter, and the final positioning information is obtained after filtering by the adaptive Kalman filter.

Additional aspects and advantages of the disclosure will be set forth in part in the following description, and in part will be obvious from the following description, or may be learned by practice of the disclosure.

The visual locator can obtain movement in six degrees of freedom (position and attitude) of the vision sensor and obtain the relative positioning information of the autonomous mobile robot. However, positioning errors may accumulate over time, and it can't provide long-term reliable positioning for the indoor autonomous mobile robot. The UWB locator has characteristics of low power consumption and high bandwidth, and can transmit a large amount of data with low power consumption. Meanwhile, the UWB locator has strong penetrating power and higher positioning accuracy. Due to multipath effect, non-line of sight (NLOS) and other factors, a simple UWB locator cannot provide stable, reliable and accurate positioning information for indoor mobile vehicles. In order to overcome shortcomings of above two positioning schemes and adapt to complex indoor scenes, in the disclosure, the first position information and the second position information are fused through by the adaptive Kalman filter to obtain the final positioning information. After fusion, the UWB locator can correct the accumulated error caused by visual positioning, and at the same time, visual positioning can smooth measured data of the UWB locator to make up for deficiencies.

### BRIEF DESCRIPTION OF THE DRAWINGS

FIG. 1 is a general frame diagram of a method for positioning an indoor autonomous mobile robot according to the present disclosure;

FIG. 2 is a visual positioning flowchart of a method for positioning an indoor autonomous mobile robot according to the present disclosure;

FIG. 3 is a layout diagram of an indoor UWB locator positioning scheme of a method for positioning an indoor autonomous mobile robot according to the present disclosure; and

FIG. 4 is a flow chart of fusion of data of a visual locator and data of a UWB locator of a method for positioning an indoor autonomous mobile robot according to the present disclosure.

### DETAILED DESCRIPTION

Embodiments of the present disclosure will be described in detail below, examples of which are shown in the accompanying drawings, in which same or similar reference numerals refer to same or similar elements or elements with same or similar functions throughout. The embodiments described below with reference to the drawings are exemplary and are intended to explain the present disclosure, but should not be construed as limiting the present disclosure.

A method for positioning an indoor autonomous mobile robot according to an embodiment of the present disclosure will be described in detail below with reference to the drawings.

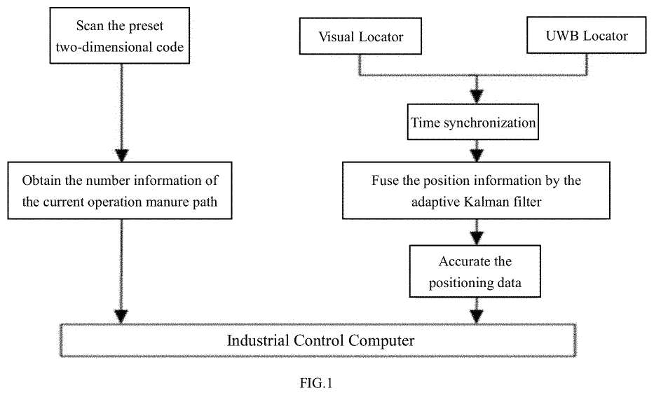

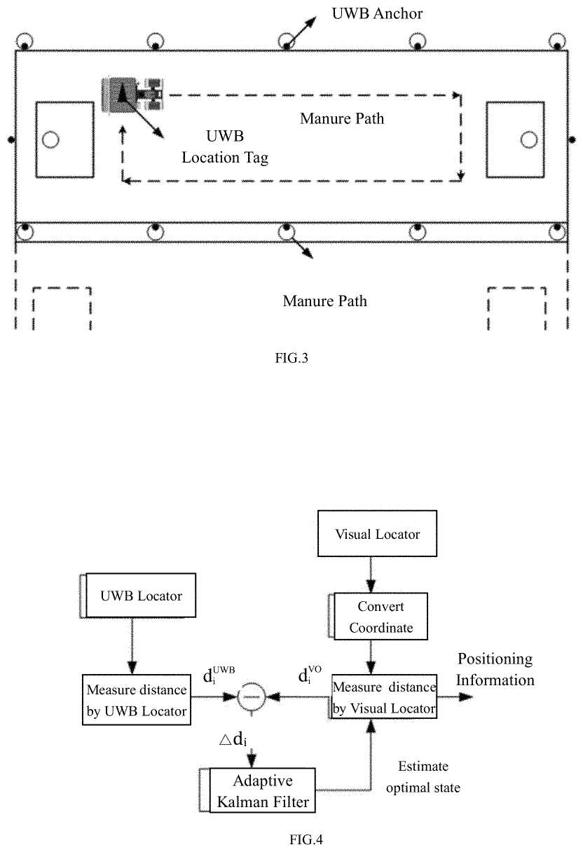

As shown in FIG. 1 and FIG. 3, a method for positioning an indoor autonomous mobile robot includes following content.

Indoor layout of moving paths and indoor relative position information of the moving path are obtained by a vision sensor on the autonomous mobile robot.

The autonomous mobile robot is provided with a visual locator, and visual positioning is performed by the visual locator on indoor image data collected by the visual sensor to obtain the first position information.

The autonomous mobile robot is provided with an ultra-wide band (UWB) location tag, and second position information of the UWB location tag is obtained and solved by an UWB locator.

An adaptive Kalman filter is constructed, and the adaptive Kalman filter is configured for fusing the first position information and the second position information to obtain final positioning information.

The visual locator can obtain movement in six degrees of freedom (position and attitude) of the vision sensor and obtain the relative positioning information of the autonomous mobile robot. However, positioning errors may accumulate over time, and it can't provide long-term reliable positioning for the indoor autonomous mobile robot. The UWB locator has characteristics of low power consumption and high bandwidth, and can transmit a large amount of data with low power consumption. Meanwhile, the UWB locator has strong penetrating power and higher positioning accuracy. Due to multipath effect, non-line of sight (NLOS) and other factors, a simple UWB locator cannot provide stable, reliable and accurate positioning information for indoor autonomous mobile robot. In order to overcome shortcomings of above two positioning schemes and adapt to complex indoor scenes, in the disclosure, an adaptive Kalman filter is constructed and the first position information and the second position information are fused through by the adaptive Kalman filter to obtain the final positioning information. After fusion, the UWB locator can correct the accumulated error caused by visual positioning, and at the same time, visual positioning can smooth measured data of the UWB locator to make up for deficiencies.

The modern piggery factory has a multi-layered structure, with dozens of manure paths on each floor, respective ones of which are roughly but not completely the same. The cleaning robot can be a manure cleaning robot, and the visual sensor is a Kinect 2.0 RGBD camera produced by Microsoft. The manure cleaning robot usually takes turns to operate in multiple manure paths. In order to enable the manure cleaning robot to obtain a relative position of a current operation manure path in the whole piggery, all of the manure paths in the piggery were numbered in advance, and layout and relative position information of all of the manure paths in the piggery were integrated and characterized by two-dimensional codes. Finally, an obtained two-dimensional code is sprayed to a part of an entrance of the manure path which is not blocked, for scanning and reading by the manure cleaning robot. In this way, the indoor layout of the moving paths and indoor relative position information of the moving paths can be obtained, and the autonomous mobile robot can obtain the layout and relative position information of the moving paths. When the autonomous mobile robot, i.e., the manure cleaning robot, enters the operation manure path, the carried vision sensor identify and scan the two-dimensional code, and read a number of the current operation manure path and relative position information of the current operation manure path in the whole piggery.

The autonomous mobile robot is provided with the visual locator, and the visual locator collects the indoor image data for visual positioning so as to obtain the first position information, which specifically includes following content.

The visual sensor collects the image data in the manure path in real time at a frame rate of 30 frames/second, and takes images of two consecutive frames.

Common key points are extracted from the images of two consecutive frames so as to obtain depth coordinates of the key points.

Mismatched points are removed in a matching pair to improve accuracy of visual positioning.

According to the depth coordinates, the trajectory of the autonomous mobile robot moving in the manure path is obtained by continuous iteration.

A specific process is as follows.

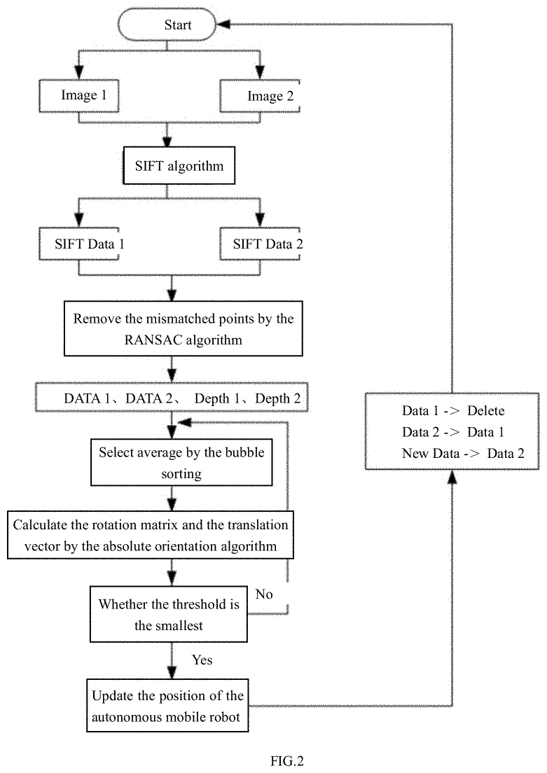

As shown in FIG. 2, the carried vision sensor collects the image data in the manure path in real time at a frame rate of 30 frames/second, and the images of two consecutive frames taken are Image1 and Image2 respectively. Firstly, the common key points are extracted from the images (Image1 and Image2) using an SIFT algorithm, and the coordinates of image points (SIFTData1 and SIFTData2) in a RGB image are obtained respectively. Then, depth coordinates (Depth1 and Depth2) of the key points and distances d from the key points to the vision sensor are obtained from a depth image. SIFTData1 and SIFTData2 respectively represent coordinates of all of common key points extracted from Image1 and Image2 by the SIFT algorithm.

A scale space is defined as follows.

L(x,y,σ)=G(x,y,σ)×I(x,y) (1)

where L consists of coordinates (x, y) of a respective key point and σ, and σ is a scale value. Here, “×” indicates a convolution operation, and I(x, y) is an original image, G(x, y, σ) means Gaussian blur, which is defined as follows:

$$G ( x , y , σ ) = \frac{1}{2 π {σ}^{2}} {e}^{- \frac{{( x - \frac{m}{2} )}^{2} + {( y - \frac{n}{2} )}^{2}}{2 {σ}^{2}}} \qquad ( 2 )$$

where m and n represent dimensions of a Gaussian blur template, (x, y) represents a position of a pixel in the image, and σ represents the scale value. The larger the scale value, the more profile features of the image. The smaller the scale value, the more detailed the features of the image.
With equation (3), a Gaussian difference scale space can be constructed, where k is a constant.

D(x,y,σ)·I(x,y)=[G(x,y,kσ)−G(x,y,σ)]·I(x,y)=L(x,y,kσ)−L(x,y,σ) (3)

In the scale space, 26 points between a detected point of a middle layer and eight adjacent points of a same scale and 9×2 points corresponding to adjacent scales of an upper layer and a lower layer are compared. If a point is with a maximum or minimum value, it is an extreme value of a candidate feature point on the image. After all of candidate feature points are extracted, further screening operation is performed, including noise removal and edge effect. A group of candidate points are fitted to a three-dimensional quadratic function to remove points with low contrast, and then the edge effect is determined according to a principal curvature of a candidate to be selected.

A direction value of each of the key points is specified by gradient direction distribution characteristics of neighboring key pixels, which makes a operator be with rotational invariance.

m(x,y)={square root over ((L(x+1,y)−L(x−1,y))²+(L(x,y+1))−L(x,y−1)²)} (4)

θ(x,y)=tan⁻¹((L(x,y+1)−L(x,y−1))/(L(x+1,y)−L(x−1,y))) (5)

where L represents coordinates (x, y) of a key point without the scale value σ. The above are a modulus equation and a direction equation of gradient at (x, y).

The mismatched points in the matching pair are removed by using a random sampling consistency (RANSAC) algorithm, so as to obtain the location information (Data1, Data2). Because there are mismatched points in a matching process, Data1 and Data2 are coordinates of a key point remained after the mismatched points in the matching pair are removed by using the RANSAC algorithm. By using a bubble sorting, four key points with large distances are selected, and then an average of three-dimensional coordinates of nearby points around these four points is taken as a correct result to improve accuracy of visual sensor data. Data1, Data2, Depth1 and Depth2 are the coordinates of all of the key points in two consecutive images after successful matching and screening. The four points selected by the bubble sorting are selected from successfully matched key points for averaging, which is essentially to optimize Data1, Data2, Depth1 and Depth2.

An absolute orientation algorithm is used to calculate a rotation matrix, from which directions (three directions) are obtained, and an offset between two positions is a calculated distance between two points. The manure cleaning robot was originally located at an origin of a coordinate system. When the manure cleaning robot moves further to a third position through first and second positions, a new feature point is obtained as a new Data2, and a feature point obtained at the second position is replaced with a new Data1. After the data is updated, a relative motion parameter of the manure cleaning robot from the second point to the third point are calculated through the new Data1 and Data2, and the trajectory of the manure-cleaning robot moving in space is obtained through continuous iteration.

The manure cleaning robot is provided with an UWB location tag, and the second position information of the UWB location tag is obtained and solved by an UWB locator, which specifically includes following content.

The manure cleaning robot is provided with the UWB location tag, and a plurality of UWB anchors are provided around each manure path.

By measuring signal time from the UWB location tag to the UWB anchor, a distance from the UWB location tag to the UWB anchor is obtained, and the second position information of the UWB location tag is calculated and obtained.

A specific process is as follows.

Twelve UWB anchors are provided around each manure path in advance (a number and position are determined according to a venue size), and the UWB location tag is installed on the manure cleaning robot. The coordinates of the location tag in three-dimensional space are calculated by using an ultra-wide band algorithm through a distance between the UWB location tag and respective UWB anchor.

Referring to a fusion scheme of UWB and other sensors, a tight coupling or loose coupling method can be used. In a loose coupling method, for an UWB original distance measurement position estimation is firstly obtained by triangulation or a least square method, and then, the UWB position estimation is used as data integrated with other sensors. Contrary to the loose coupling, original TOA measurement of each anchor is directly used for a tight coupling method. Because it is required for the loose coupling method to preprocess the original UWB measurement data, the second position information of the UWB location tag may be lost in some cases. By means of the tight coupling method, we can make full use of existing information for UWB. Therefore, for UWB and the vision sensor, the tight coupling method is adopted in this paper.

In the disclosure a TOA positioning algorithm is adopted, a distance from the UWB location tag to the UWB anchor is obtained by measuring signal time from the UWB location tag to the UWB anchor. Three or more circles are drawn with the UWB anchor as a center and the distance as a radius. Intersections of the circles are positions of the location tag. Its equation is as follows:

$${t}_{i} = {τ}_{i} + {t}_{0} = \frac{{d}_{i}}{c} + {t}_{0} = \frac{\sqrt{{( {x}_{i} - x )}^{2} + {( {y}_{i} - y )}^{2} + {( {z}_{i} - z )}^{2}}}{c} + {t}_{0} \qquad ( 6 )$$

In equation (1), to is time to send a signal from the tag. This is the time when the UWB anchor receives the signal. τ is propagation time of the signal from the UWB location tag to the UWB anchor. di is a distance from the UWB location tag to the anchor. (xᵢ, yᵢ, zᵢ) and (x, y, z) are coordinates of the UWB anchor and the UWB location tag, respectively. In a three-dimensional coordinate solution, equation (6) can be converted into a form of equation (7):

dᵢ=\sqrt{(xᵢ−x)²(yᵢ−y)²+(zᵢ−z)²} (i=1,2,3, . . . ,n) (7)

X=(x,y,z)^{T} is coordinates of the tag. Because a number of the UWB anchors is at least three or more, there are redundant observations in calculating the coordinates of the tag, so the least square adjustment calculation can be carried out. Its equation is as follows:

AX=L (8)

A, L can be calculated according to the coordinates of the UWB anchor and the distance from the UWB location tag to the UWB anchor, as shown in formulas (7) and (8). v is an observed residual error, as shown in formula (11)

$$A = [ {x}_{( i + 1 )} - {x}_{1} , {y}_{( i + 1 )} - {y}_{1} , {z}_{( i + 1 )} - z ] ( i = 1 , 2 , 3 , , n ) \qquad ( 9 )$$

$$\{ \begin{matrix}\begin{matrix}L = 0.5 \times [ {( {x}_{i + 1} )}^{2} - {( {x}_{1} )}^{2} + {( {y}_{i + 1} )}^{2} - {( {y}_{1} )}^{2} + \\ {( {z}_{i + 1} )}^{2} - {( {z}_{1} )}^{2} + {( {d}_{1} )}^{2} - {( {d}_{i + 1} )}^{2} ]\end{matrix} \\ ( i = 1 , 2 , 3 , … , n )\end{matrix} \qquad ( 10 )$$

$$V = AX - L \qquad ( 11 )$$

$$X = {( {A}^{T} P A )}^{- 1} {A}^{T} P L \qquad ( 12 )$$

The coordinates of the label can be calculated by equation (12).

After the first position information and the second position information are time synchronized, the first position information and the second position information are fused by the adaptive Kalman filter to obtain the final positioning information.

A specific process is as follows.

Output data of the visual locator must be synchronized with data of the UWB locator in time. Based on computing requirements between a software mechanism and the system, a frequency of a sensing module of the visual locator is set to be 1 Hz, and a sampling frequency of the UWB locator can be set to be 100 Hz. The RGB and depth images collected by the vision sensor are saved together with the world time in the computer through a program algorithm on the computer, so does a time label of the data of the UWB locator is the same. Both of them are related to the world time in the computer. After the data of visual locator and UWB locator are time stamped, interpolation and alignment are carried out to achieve time synchronization, which provides conditions for data fusion by using the Kalman filter.

The first position information and the second position information are fused by the adaptive Kalman filter, to obtain the final positioning information. Further, the first position information is converted into a measured distance value; that is, after measured distance values of the UWB locator and the visual locator are obtained respectively, difference between the measured distance values of the UWB locator and the visual locator is configured as a measurement input of the adaptive Kalman filter, and the final positioning information is obtained after filtering by the adaptive Kalman filter.

A specific process is as follows.

As shown in FIG. 4, data information of the UWB locator is an original distance measurement dᵢ^{UWB} (i=0, 1, 2, 3 . . . n), and the measurement information is distances from the location tag to the provided N anchors. However, based on a vision positioning method, the relative position with depth information can be obtained, but a distance from the UWB anchor cannot be output as the UWB locator, which needs further processing. It usually takes two steps to convert the relative position obtained by the visual locator into the distance measurement similar to the UWB locator. Step 1: it is required to be converted into global position coordinates because the visual locator acquires relative position information of the carrier. Step 2: an Euclidean distance from the visual global position coordinates to the provided anchor can be calculated according to the known coordinates of the anchor in X, Y and Z directions. The resulting Euclidean distance (i=0, 1, 2, 3 . . . n) is the measured distance value of the visual locator.

According to a shown fusion system structure, after the measured distance values of the UWB visual locator and the visual locator are obtained respectively, difference between dᵢ^{UWB} and dᵢ^{VO} is configured as the measurement input of the adaptive Kalman filter, and a optimal state estimation is obtained after filtering by the adaptive Kalman filter. Then the filtered optimal state estimation is fed back to the distance measurement of the vision sensor. Then the least square method is used to solve the corrected distance dᵢ^{VO} of the visual locator, so as to obtain the final positioning information of the fusion system.

The Kalman filter usually uses a linear system state equation, combined with other input information and observation data, to estimate the optimal state of the system. The Kalman filter needs an estimated value of the system state at a previous moment and observed information at a current moment to estimate the optimal value of the current state. The Kalman filter is widely used in engineering field because it is easy to be programed, and can process and update collected data in real time.

A system model of the disclosure is linear, and thus a linear Kalman filter is adopted. Because the system model and noise characteristics affect performance of the Kalman filter, it is difficult to obtain statistical characteristics of noise in practical applications. On this basis, the adaptive Kalman filter is adopted to dynamically estimate a covariance matrix Q for system noise and a covariance matrix R for observation noise.

In the Kalman filter used in this paper, the system state equation is as follows:

xₖ=AXₖ₋₁+ωₖ (13)

where xₖ represents a system state vector of the fusion system at time k, and A represents a state transition matrix from time k−1 to time k, ωₖ represents the system noise, which is Gaussian white noise which satisfies ωₖ˜N(0, Q). xₖ is specifically defined as follows, which indicates an error of the location tag to the distance of a respective anchor. The state transition matrix A is an n-order identity matrix.

xₖ=[Δd₀Δd₁Δd₂Δd₃ . . . Δdₙ]^{T} (14)

A measurement formula of the fusion system is:

zₖ=Hxₖ+vₖ (15)

where zₖ is an observation vector of the fusion system at time k, H is an observation matrix, and n represents a number of the UWB anchors. vₖ represents the observation noise, which is Gaussian white noise which satisfies vₖ˜N(0, R). zₖ is specifically defined as follows, which indicates difference between the distance dᵢ^{VO} obtained by a visual location system and the distance dᵢ^{UWB} of the UWB locator. The observation matrix H is an n-order identity matrix.

zₖ=[d₀^{VO}−d₀^{UWB}d₁^{VO}−d₁^{UWB}d₂^{VO}−d₂^{UWB}d₃^{VO} . . . −dₙ₋₁^{UWB}dₙ^{VO}−dₙ^{UWB}]^{T} (16)

According to variable parameters defined above, a complete prediction process of the adaptive Kalman filter is as follows. Where \hat{x}ₖ₋₁ represents optimal state estimation at time k−1, and \hat{x}_{k,k-1} a predicted value of the state at time k obtained from the system state equation. Pₖ₋₁ represents an error covariance matrix between an updated state value and a true value at time k−1. P_{k,k-1} represents a covariance matrix of the error between the predicted value and the true value of the state at time k.

$${\hat{x}}_{k , k - 1} = A {\hat{x}}_{k - 1} \qquad ( 17 )$$

$${v}_{k} = {z}_{k} - H {\hat{x}}_{k , k - 1} \qquad ( 18 )$$

$${\hat{V}}_{k} = \frac{1}{k} {Σ}_{i = 1}^{k} {v}_{i} {v}_{i}^{T} \qquad ( 19 )$$

$${Q}_{k} = {K}_{k - 1} {\hat{V}}_{k} {K}_{k - 1}^{T} \qquad ( 20 )$$

$${P}_{k , k - 1} = A {P}_{k - 1} {A}^{T} + {Q}_{k} \qquad ( 21 )$$

A complete updating process of the adaptive Kalman filter is as follows, in which Kₖ represents a Kalman gain matrix and Pₖ represents the covariance matrix of the error between the updated value and the true value at time k. During iterations, the covariance matrix Qₖ for the system noise and the covariance matrix Rₖ for the observation noise are dynamically updated.

Rₖ=\hat{V}ₖ−HP_{k,k-1}H^{T} (22)

Kₖ=P_{k,k-1}H^{T}[HP_{k,k-1}H^{T}+Rₖ]⁻¹ (23)

\hat{x}ₖ=\hat{x}_{k,k-1}+Kₖvₖ (24)

Pₖ=(I−K_{K}H)P_{k,k-1} (25)

In the description of this specification, description referring to terms “one embodiment”, “some embodiments”, “examples”, “specific examples” or “some examples” means that specific features, structures, materials or characteristics described in connection with this embodiment or example are included in at least one of embodiments or examples of the present disclosure. In this specification, schematic expressions of the above terms do not necessarily refer to a same embodiment or example. Furthermore, the specific features, structures, materials or characteristics described may be combined in any one or more of embodiments or examples in a suitable manner. In addition, those skilled in the art can incorporate and combine different embodiments or examples or features of different embodiments or examples described in this specification without mutual inconsistence.

Although the embodiments of the present disclosure have been shown and described above, it is to be understood that the above embodiments are illustrative and should not be construed as limitations of the present disclosure, and changes, modifications, substitutions and variations to the above embodiments can be made by those skilled in the art within the scope of the present disclosure.

For those skilled in the art, upon reading the above description, various changes and modifications will undoubtedly be obvious. Therefore, the appended claims should be regarded as covering all changes and modifications of true intention and scope of the disclosure. Any and all equivalent ranges and contents within the scope of the claims should be considered as still falling within the intention and scope of the present disclosure.

What is claimed is:

1. A method for positioning an indoor autonomous mobile robot, comprising:
obtaining indoor layout of moving paths and indoor relative position information of the moving path by a vision sensor on the autonomous mobile robot;
providing a visual locator on the autonomous mobile robot, and performing visual positioning by the visual locator on indoor image data collected by the visual sensor to obtain first position information;
providing an UWB location tag on the autonomous mobile robot, and obtaining and solving second position information of the UWB location tag by an UWB locator; and
fusing the first position information and the second position information by an adaptive Kalman filter, to obtain final positioning information of the autonomous mobile robot.

2. The method for positioning the indoor autonomous mobile robot according to claim 1, wherein obtaining the layout of the moving paths and the relative position information of the moving paths specifically comprises:
numbering the indoor moving paths, and integrating the layout of the moving paths and the indoor relative position information of the moving paths, characterizing the moving paths by using two-dimensional codes; and identifying, by the vision sensor, the two-dimensional codes to obtain respective layout and relative position information of the moving paths.

3. The method for positioning the indoor autonomous mobile robot according to claim 1, wherein performing the visual positioning by the visual locator on the indoor image data collected by the visual sensor to obtain the first position information specifically comprises:
collecting the indoor image data by the vision sensor in real time at a preset frame rate, and taking images of two consecutive frames;
extracting common key points from the images of two consecutive frames so as to obtain depth coordinates of the key points;
removing mismatched points in a matching pair to improve accuracy of visual positioning; and
obtaining a trajectory of the autonomous mobile robot moving in indoor according to continuous iteration for the depth coordinates.

4. The method for positioning the indoor autonomous mobile robot according to claim 1, wherein obtaining and solving the second position information of the UWB location tag by the UWB locator specifically comprises:
providing the UWB location tag on the autonomous mobile robot and providing a plurality of UWB anchors around the moving paths; and
by measuring signal time from the UWB location tag to the UWB anchor, obtaining a distance from the UWB location tag to the UWB anchor, and calculating and obtaining the second position information of the UWB location tag.

5. The method for positioning the indoor autonomous mobile robot according to claim 1, wherein after the first position information and the second position information are time synchronized, the first position information and the second position information are fused by the adaptive Kalman filter to obtain the final positioning information.

6. The method for positioning the indoor autonomous mobile robot according to claim 5, wherein the first position information and the second position information are fused to obtain the final positioning information, which specifically comprises: converting the first position information into a measured distance value; that is, after measured distance values of the UWB locator and the visual locator are obtained respectively, configuring difference between the measured distance values of the UWB locator and the visual locator as a measurement input of the adaptive Kalman filter, and obtaining the final positioning information after filtering by the adaptive Kalman filter.

7. The method for positioning the indoor autonomous mobile robot according to claim 3, wherein the images of two consecutive frames are Image1 and Image2 respectively, the common key points are extracted from Image1 and Image2 by using an SIFT algorithm to obtain coordinates of image points SIFTData1 and SIFTData2 in a RGB image respectively, and the depth coordinates Depth1 and Depth2 of the key points and distances d from the key points to the vision sensor are obtained from a depth image.

8. The method for positioning the indoor autonomous mobile robot according to claim 7, wherein extracting the key points by using the SIFT algorithm specifically comprises:
extracting candidate feature points:
L(x,y,σ)=G(x,y,σ)×I(x,y) (1)
where L(x,y,σ) represents a Gaussian scale space of an image, and a symbol “X” represents convolution operation, I(x,y) is an original image, (x, y) represents coordinates of points on the original image, and G(x, y, σ) represents a Gaussian kernel function.
$$G ( x , y , σ ) = \frac{1}{2 π {σ}^{2}} {e}^{- \frac{{( x - \frac{m}{2} )}^{2} + {( y - \frac{n}{2} )}^{2}}{2 {σ}^{2}}} \qquad ( 2 )$$
where m and n represent dimensions of a Gaussian blur template, and σ is called a scale space factor;
D(x,y,σ)·I(x,y)=[G(x,y,kσ)−G(x,y,σ)]·I(x,y)=L(x,y,kσ)—L(x,y,σ) (3)
constructing a Gaussian difference scale space using equation (3), where k is a constant; and
screening the candidate feature points to obtain a modulus equation and a direction equation of the key points:
m(x,y)={square root over ((L(x+1,y)−L(x−1,y))²+(L(x,y+1))−L(x,y−1)²)} (4)
θ(x,y)=tan⁻¹((L(x,y+1)−L(x,y−1))/(L(x+1,y)−L(x−1,y))) (5)
where L represents coordinates (x, y) of a key point without a scale value σ.

9. The method for positioning the indoor autonomous mobile robot according to claim 7, wherein the mismatched points in the matching pair are removed by using a RANSAC algorithm, so as to obtain the location information Data1 and Data2;
by using a bubble sorting, four key points with large distances are selected, and an average of three-dimensional coordinates of nearby points around these four key points is taken as a correct result;
an absolute orientation algorithm is used to calculate a rotation matrix and a translation vector, and a trajectory of the autonomous mobile robot moving in space is obtained through continuous iteration.

10. The method for positioning the indoor autonomous mobile robot according to claim 4, wherein the signal time from the UWB location tag to the UWB anchor is measured by a TOA algorithm so as to measure and obtain the distance from the UWB location tag to the UWB anchor, which specifically as follows:
$${t}_{i} = {τ}_{i} + {t}_{0} = \frac{{d}_{i}}{c} + {t}_{0} = \frac{\sqrt{{( {x}_{i} - x )}^{2} + {( {y}_{i} - y )}^{2} + {( {z}_{i} - z )}^{2}}}{c} + {t}_{0} \qquad ( 6 )$$
where t₀ is time to send a signal from the tag, tᵢ is the time when the anchor receives the signal, τᵢ is propagation time of the signal from the tag to the anchor, and dᵢ is the distance from the tag to the anchor, (xᵢ, yᵢ, zᵢ) and (x, y, z) are coordinates of the UWB anchor and the UWB location tag, respectively, which are converted into a 3D coordinate system:
dᵢ=\sqrt{(xᵢ−x)²(yᵢ−y)²+(zᵢ−z)²} (i=1,2,3, . . . ,n) (7)
where, X=(x, y, z) is the coordinates of the UWB location tag;
then, the coordinates of the UWB location tag are calculated by a least square method as follows:
$$AX = L \qquad ( 8 )$$
$$A = [ {x}_{( i + 1 )} - {x}_{1} , {y}_{( i + 1 )} - {y}_{1} , {z}_{( i + 1 )} - z ] ( i = 1 , 2 , 3 , , n ) \qquad ( 9 )$$
$$\{ \begin{matrix}\begin{matrix}L = 0.5 \times [ {( {x}_{i + 1} )}^{2} - {( {x}_{1} )}^{2} + {( {y}_{i + 1} )}^{2} - {( {y}_{1} )}^{2} + \\ {( {z}_{i + 1} )}^{2} - {( {z}_{1} )}^{2} + {( {d}_{1} )}^{2} - {( {d}_{i + 1} )}^{2} ]\end{matrix} \\ ( i = 1 , 2 , 3 , … , n )\end{matrix} \qquad ( 10 )$$
$$V = AX - L \qquad ( 11 )$$
$$X = {( {A}^{T} P A )}^{- 1} {A}^{T} P L \qquad ( 12 )$$
where L is calculated according to the coordinates of the UWB anchor and the distance from the UWB location tag to the UWB anchor, and v is an observed residual error.

11. The method for positioning the indoor autonomous mobile robot according to claim 6, wherein a system state equation in the adaptive Kalman filter is as follows:
xₖ=AXₖ₋₁+ωₖ (13)
where xₖ represents a system state vector of a fusion system at time k, and A represents a state transition matrix from time k−1 to time k, ωₖ represents system noise, which is Gaussian white noise which satisfies ωₖ—N(0,Q), and xₖ represents distance errors of the UWB location tag to each of the UWB anchors, and the state transition matrix A is a n-order identity matrix;
xₖ=[Δd₀Δd₁Δd₂Δd₃ . . . Δdₙ]^{T} (14)
A measurement formula of the fusion system is:
zₖ=Hxₖ+vₖ (15)
zₖ=[d₀^{VO}−d₀^{UWB}d₁^{VO}−d₁^{UWB}d₂^{VO}−d₂^{UWB}d₃^{VO} . . . −dₙ₋₁^{UWB}dₙ^{VO}−dₙ^{UWB}]^{T} (16)
where zₖ is an observation vector of the fusion system at time k, H is an observation matrix, and n represents a number of the UWB anchors, and vₖ represents observation noise, which is Gaussian white noise which satisfies vₖ˜N(0, R), zₖ represents difference between the distance dᵢ^{VO} obtained by a visual location system and the distance dᵢ^{UWB} of the UWB locator, and the observation matrix H is an n-order identity matrix.

12. The method for positioning the indoor autonomous mobile robot according to claim 11, wherein a complete prediction process of the adaptive Kalman filter is as follows:
$${\hat{x}}_{k , k - 1} = A {\hat{x}}_{k - 1} \qquad ( 17 )$$
$${v}_{k} = {z}_{k} - H {\hat{x}}_{k , k - 1} \qquad ( 18 )$$
$${\hat{V}}_{k} = \frac{1}{k} {Σ}_{i = 1}^{k} {v}_{i} {v}_{i}^{T} \qquad ( 19 )$$
$${Q}_{k} = {K}_{k - 1} {\hat{V}}_{k} {K}_{k - 1}^{T} \qquad ( 20 )$$
$${P}_{k , k - 1} = A {P}_{k - 1} {A}^{T} + {Q}_{k} \qquad ( 21 )$$
where \hat{x}ₖ₋₁ represents optimal state estimation at time k−1, and \hat{x}_{k,k-1} a predicted value of the state at time k obtained from the system state equation, Pₖ₋₁ represents an error covariance matrix between an updated state value and a true value at time k−1, and P_{k,k-1} represents a covariance matrix of the error between the predicted value and the true value of the state at time k.

13. The method for positioning the indoor autonomous mobile robot according to claim 11, wherein a complete updating process of the adaptive Kalman filter is as follows:
Rₖ=\hat{V}ₖ−HP_{k,k-1}H^{T} (22)
Kₖ=P_{k,k-1}H^{T}[HP_{k,k-1}H^{T}+Rₖ+Rₖ]⁻¹ (23)
\hat{x}ₖ=\hat{x}_{k,k-1}+Kₖvₖ (24)
Pₖ=(I−K_{K}H)P_{k,k-1} (25)
where Kₖ represents a Kalman gain matrix and Pₖ represents the covariance matrix of the error between the updated value and the true value at time k, and during iterations, the covariance matrix Qₖ for the system noise and the covariance matrix Rₖ for the observation noise are dynamically updated.

14. A system for positioning an indoor autonomous mobile robot, comprising:
a recognizer configured for obtaining preset layout of moving paths and relative position information of the moving paths;
a visual locator configured for collecting indoor image data for visual positioning to obtain first position information;
a UWB locator configured for obtaining signal time and distances from the UWB location tag to a plurality of UWB anchors provided on the moving path, and solving the second position information of the UWB location tag; and
an adaptive Kalman filter configured for fusing the first position information and the second position information to obtain final positioning information.

15. The system for positioning the indoor autonomous mobile robot according to claim 14, further comprising a memory device which is configured to number the indoor moving paths and integrate the layout and relative position information of the moving paths so as to be stored in the memory device, and then characterize the moving paths by using two-dimensional codes, so that the recognizer identifies the two-dimensional codes to obtain respective layout and relative position information of the moving paths.

16. The system for positioning the indoor autonomous mobile robot according to claim 14, wherein collecting the indoor image data for visual positioning to obtain the first position information specifically comprises:
collecting the indoor image data by the vision sensor in real time at a preset frame rate, and taking images of two consecutive frames;
extracting common key points from the images of two consecutive frames so as to obtain depth coordinates of the key points;
obtaining a trajectory of the autonomous mobile robot moving in space according to continuous iteration for the depth coordinates.

17. The system for positioning the indoor autonomous mobile robot according to claim 14, wherein obtaining and solving the second position information of the UWB location tag by the UWB locator specifically comprises:
by measuring signal time from the UWB location tag to the UWB anchor, obtaining a distance from the UWB location tag to the UWB anchor, and calculating and obtaining the second position information of the UWB location tag.

18. The system for positioning the indoor autonomous mobile robot according to claim 14, wherein after the first position information and the second position information are time synchronized, the first position information is converted into a measured distance value; that is, after measured distance values of the UWB locator and the visual locator are obtained respectively, difference between the measured distance values of the UWB locator and the visual locator is configured as a measurement input of the adaptive Kalman filter, and the final positioning information is obtained after filtering by the adaptive Kalman filter.
